(19) United States
(12) Patent Application Publication
(10) Pub. No.: US 2016/0080246 A1
(43) Pub. Date: Mar. 17, 2016

(54) Offloading Tenant Traffic in Virtual Networks

(71) Applicant: Futurewei Technologies, Inc., Plano, TX (US)

(72) Inventors: Lucy Yong, Georgetown, TX (US); Andrew G. Malis, Andover, MA (US)

(21) Appl. No.: 14/485,400

(22) Filed: Sep. 12, 2014

(51) Int. Cl. H04L 12/715

(52) U.S. Cl. CPC H04L 45/04

(57) ABSTRACT

An apparatus comprising a receiver configured to receive an offload traffic notification from tenant service system, and a processor coupled to a memory and the receiver, where the memory comprises computer executable instructions stored in a non-transitory computer readable medium, that when executed by the processor, cause the processor to receive the offload traffic notification, wherein the offload traffic notification identifies a sender tenant system and a receiver tenant system and comprises policy information, determine a network mapping between a network virtualization edge (NVE) that is associated with the receiver tenant system and the receiver tenant system, generate a network mapping message that comprises the network mapping, and send the network mapping message and policy information within a network to an NVE that is associated with a sender tenant system.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Network virtualization overlay (NVO) is a technology that creates virtual networks in an overlay for a data center (DC) for a plurality of tenants. NVO is described in more detail in the Internet Engineering Task Force (IETF) document, draft-ietf-nvo3-arch-01, published Oct. 22, 2013 and the IETF document, draft-ietf-nvo3-framework-09, published Jan. 4, 2014, both of which are incorporated herein by reference as if reproduced in their entirety. With NVO, one or more tenant networks may be built over a common DC network infrastructure where each of the tenant networks comprises one or more virtual overlay networks. Each of the virtual overlay networks may have an independent address space, independent network configurations, and traffic isolation amongst each other. For example, an NVO may be implemented using an Internet Protocol (IP) underlay network and may comprise a plurality of tenant systems coupled to a plurality of network virtualization edges (NVEs). Tenant traffic between the tenant systems may pass through a tenant service system, tenant service function, and/or a tenant application. Communication policies may be installed on a tenant service function which may be applied to tenant traffic that is being communicated between a pair of NVEs. A service provider may offer a Layer 3 (L3) virtual private network (VPN) to an enterprise company that may comprise a hub site and one or more spoke sites. The enterprise company may be configured, such that, tenant traffic between any spoke sites passes through a tenant service system where a policy is enforced. As such, tenant traffic or tenant traffic flows may be routed to the tenant service system to apply one or more tenant service functions, but may not be routed directly between branch sites without applying the tenant service functions.

### SUMMARY

In one embodiment, the disclosure includes an apparatus comprising a receiver configured to receive an offload traffic notification from tenant service system, and a processor coupled to a memory and the receiver, where the memory comprises computer executable instructions stored in a non-transitory computer readable medium, that when executed by the processor, cause the processor to receive the offload traffic notification, wherein the offload traffic notification identifies a sender tenant system and a receiver tenant system and comprises policy information, determine a network mapping between an NVE that is associated with the receiver tenant system and the receiver tenant system, generate a network mapping message that comprises the network mapping, and send the network mapping message and policy information within a network to an NVE that is associated with a sender tenant system.

In another embodiment, the disclosure includes a traffic offloading method comprising receiving a policy information that comprises one or more policies and a network mapping message that comprises a network mapping between a receiver tenant system and an NVE associated with the receiver tenant system, generating a policy based routing entry in accordance with the policy information and the network mapping information, receiving tenant traffic intended for the receiver tenant system from a sender tenant system, and sending the tenant traffic within a network to an NVE associated with the receiver tenant system using the policy based routing entry, wherein sending the tenant traffic using the policy based routing applies the policy information to the tenant traffic, and wherein sending the tenant traffic using the policy base routing entry bypasses a tenant service system.

In yet another embodiment, the disclosure includes a traffic offloading method comprising receiving an offload traffic notification, wherein the offload traffic notification identifies a sender tenant system and a receiver tenant system and comprises policy information, and wherein the offload traffic notification indicates a bidirectional traffic flow between the sender tenant system and the receiver tenant system, determining a first network mapping between the sender tenant system and an NVE associated with the sender tenant system and a second network mapping between the receiver tenant system and an NVE associated with the receiver tenant system, generating a first network mapping message that comprises the first network mapping and a second network mapping message that comprises the second network mapping in response to receiving the offload traffic notification, and sending the first network mapping message and the policy information to the NVE associated with the receiver tenant system and the second network mapping message and the policy information to the NVE associated with the sender tenant system within a network.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a data center network virtualization overlay.

FIG. 2 is a schematic diagram of an embodiment of a network element.

FIGS. 3-5 are schematic diagrams of embodiments of tenant traffic offloading in a tenant network.

FIG. 6 is a flowchart of an embodiment of an offloading tenant traffic method.

FIG. 7 is a flowchart of another embodiment of an offloading tenant traffic method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for offloading tenant traffic in a DC architecture and/or a VPN and dynamically routing tenant traffic flows. A tenant network may be configured to automatically configure or reconfigure a tenant traffic route between a pair of tenant systems regardless of whether the tenant systems are on the same or different virtual network. One or more embodiments may enable a tenant service system to offload tenant traffic to one or more virtual networks (e.g., NVOs or VPNs). For example, a portion of the tenant traffic flows may be routed for policy enforcement before forwarding to a destination and another portion of the tenant traffic flows (e.g., video conference flows and file transferring flows) may be offloaded from the policy enforcement. One or more tenant traffic flows may initially be configured to pass through a tenant service system and a tenant service function and at a later time one or more of the tenant traffic flows may be offloaded from the tenant service function. The offloaded tenant traffic flows may be rerouted from one tenant system to another tenant system without passing through the tenant service system. Offloading tenant traffic to virtual networks may preserve resource processes and/or time on tenant service systems and may improve overall performance and user experience using gain path optimization in virtual networks. In an embodiment, a tenant service system and/or other entities behind the tenant service system may send an NVE and/or a network virtualization authority (NVA) offload traffic notification about offloading tenant traffic between two tenant systems. An offload traffic notification may indicate that tenant traffic flows between two tenant systems may no longer need to be processed by the tenant service system. Offload traffic notifications from a tenant service system to the virtual networks may be provided autonomously and/or on-demand by a network operator or controller. Upon receiving the offload traffic notification, a tenant traffic flow route may be optimized in an NVO and/or a VPN between the tenant systems and at least some of the tenant traffic flows between the tenant systems may be offloaded.

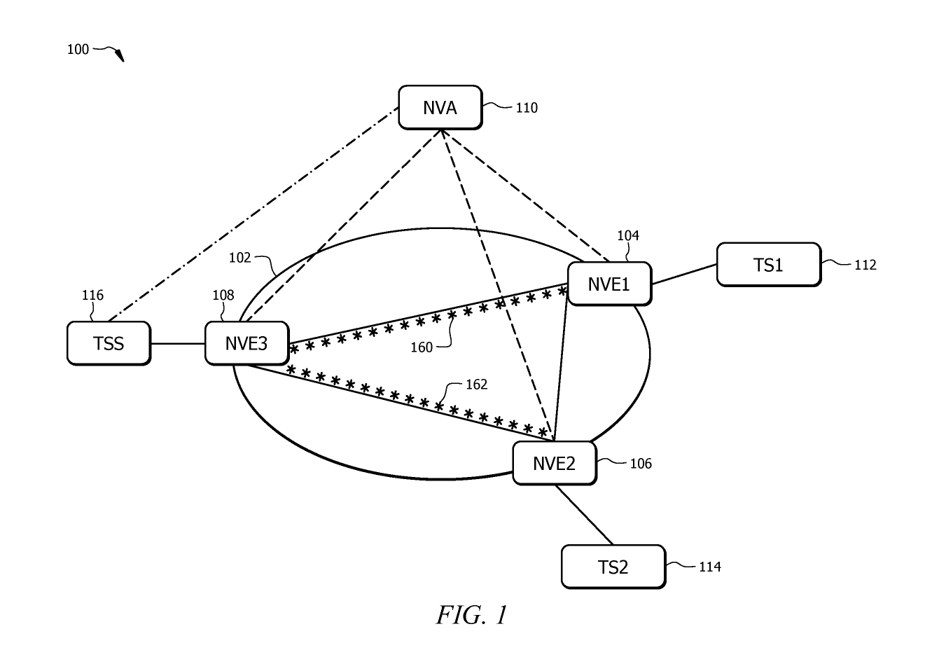

FIG. 1 is a schematic diagram of an embodiment of a DC NVO 100 where an embodiment of the present disclosure may operate. DC NVO 100 may be configured as an overlay in a DC system and may provide L2 service and/or L3 service to tenant systems over an L3 underlay network. L2 services and/or L3 services may be implemented using architectures and/or protocols described in the IETF draft draft-ietf-nvo3-framework-09.txt, titled, “Framework for DC Networking Virtualization,” by Lasserre, et al. DC NVO 100 may comprise a DC infrastructure 102 that comprises a plurality of NVEs 104-108 and an NVA 110, a plurality of tenant systems 112 and 114, and a tenant service system 116. DC infrastructure 102 may be configured to provide connectivity to the plurality of NVEs 104-108, NVA 110, the plurality of tenant systems 112 and 114, and tenant service system 116. NVEs 104-108 may be configured implemented as or incorporated within a server to implement L2 and/or L3 network virtualization functions. An NVE may be a network entity at an edge of an underlay network and may comprise a network-facing side coupled to one or more other NVEs within the underlay network and a tenant-facing side coupled to one or more tenant systems. The network-facing side of the NVE may be configured to use an underlying L3 network to tunnel tenant frames to and from other NVEs. The tenant-facing side of the NVE may be configured to send and receive Ethernet frames to and from tenant systems. In another embodiment, an NVE may be implemented as or incorporated within a virtual switch within a hypervisor, a switch, a router, a network service appliance, or any other suitable network component as would be appreciated by one of ordinary skill in the art upon viewing this disclosure. Alternatively, an NVE may be split across a plurality of network components. NVA 110 may be configured as a centralized controller (e.g., a software defined network (SDN) controller) and may be coupled to the NVEs 104-108 to provide reachability information and/or forwarding information for the NVEs 104-108. Additionally, NVA 110 may be configured to communicate with the tenant service system 116 using a communication channel. The communication channel may include, but is not limited to, a single transmission control protocol (TCP) session, a TCP session through several tenant systems, or a TCP session through a DC controller or manager. Alternatively, the communication channel may be implemented using any other suitable protocol as would be appreciated by one of ordinary skill in the art upon viewing this disclosure.

Tenant service system 116 may also be coupled to NVE 108. Tenant service system 116 may be configured to trigger tenant traffic offloading (e.g., send an offload traffic notification) and to apply and/or to enforce tenant service functions, policies, and/or applications onto tenant traffic or tenant traffic flows that pass through the tenant service system 116. A tenant service function may include, but is not limited to network services, such as a firewall, an intrusion prevention system (IPS), load balancing, and security checking. Tenant service system 116 may be configured to trigger tenant traffic offloading using an automated policy and/or may be initiated by a user command or trigger. Tenant system 112 may be coupled to NVE 104 and tenant system 114 may be coupled to NVE 106. A tenant system may be a physical system or a virtual system and may be configured as a host and/or a forwarding element, such as, a router, a switch, or a firewall. A tenant system may be assigned to a customer using a virtual system and/or any associated resource and may be coupled to one or more virtual networks. Tenant service system 116, tenant system 112, and tenant system 114 may be on or associated with one or more virtual networks 160 and 162 in an overlay. Virtual networks 160 and 162 may be the same virtual network or may be different virtual network. In an embodiment, tenant service system 116 may be configured as a server application and tenant systems 112 and 114 may be configured as clients.

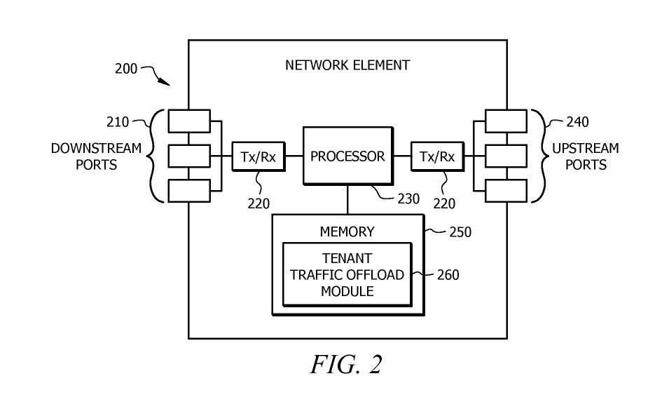

FIG. 2 is a schematic diagram of an embodiment of a network element 200 that may be used to transport and process data traffic through at least a portion of a DC NVO 100 shown in FIG. 1. At least some of the features/methods described in the disclosure may be implemented in the network element 200. For instance, the features/methods of the disclosure may be implemented in hardware, firmware, and/or software installed to run on the hardware. The network element 200 may be any device (e.g., a modem, a switch, router, bridge, server, client, etc.) that transports data through a network, system, and/or domain. Moreover, the terms network “element,” network “node,” network “component,” network “module,” and/or similar terms may be interchangeably used to generally describe a network device and do not have a particular or special meaning unless otherwise specifically stated and/or claimed within the disclosure. In one embodiment, the network element 200 may be an apparatus configured to communicate tenant traffic (e.g., data packets) and to offload tenant traffic in a virtual network overlay. For example, network element 200 may be implemented in and/or integrated within NVEs 104-108, NVA 110, tenant systems 112 and 114, and/or tenant service system 116 described in FIG. 1.

The network element 200 may comprise one or more downstream ports 210 coupled to a transceiver (Tx/Rx) 220, which may be transmitters, receivers, or combinations thereof. The Tx/Rx 220 may transmit and/or receive frames from other network nodes via the downstream ports 210. Similarly, the network element 200 may comprise another Tx/Rx 220 coupled to a plurality of upstream ports 240, wherein the Tx/Rx 220 may transmit and/or receive frames from other nodes via the upstream ports 240. The downstream ports 210 and/or the upstream ports 240 may include electrical and/or optical transmitting and/or receiving components.

A processor 230 may be coupled to the Tx/Rx 220 and may be configured to process the frames and/or determine which nodes to send (e.g., transmit) the packets. In an embodiment, the processor 230 may comprise one or more multi-core processors and/or memory modules 250, which may function as data stores, buffers, etc. The processor 230 may be implemented as a general processor or may be part of one or more application specific integrated circuits (ASICs), field-programmable gate arrays (FPGAs), and/or digital signal processors (DSPs). Although illustrated as a single processor, the processor 230 is not so limited and may comprise multiple processors. The processor 230 may be configured to validate packet forwarding and/or to identify a point of failure in a network.

FIG. 2 illustrates that a memory module 250 may be coupled to the processor 230 and may be a non-transitory medium configured to store various types of data. Memory module 250 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 250 may be used to house the instructions for carrying out the various example embodiments described herein. In one example embodiment, the memory module 250 may comprise a tenant traffic offload module 260 that may be implemented on the processor 230. In one embodiment, the tenant traffic offload module 260 may be implemented to communicate data packets through a virtual network or a virtual network overlay, to determine a network mapping, and/or to offload tenant traffic. For example, the tenant traffic offload module 260 may be configured to generate and/or receive an offload traffic notification, to generate and/or receive a network mapping message, and to offload tenant traffic in a virtual network in response to the offload traffic notification and the network mapping message. Tenant traffic offload module 260 may be implemented in a transmitter (Tx), a receiver (Rx), or both.

It is understood that by programming and/or loading executable instructions onto the network element 200, at least one of the processors 230, the cache, and the long-term storage are changed, transforming the network element 200 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

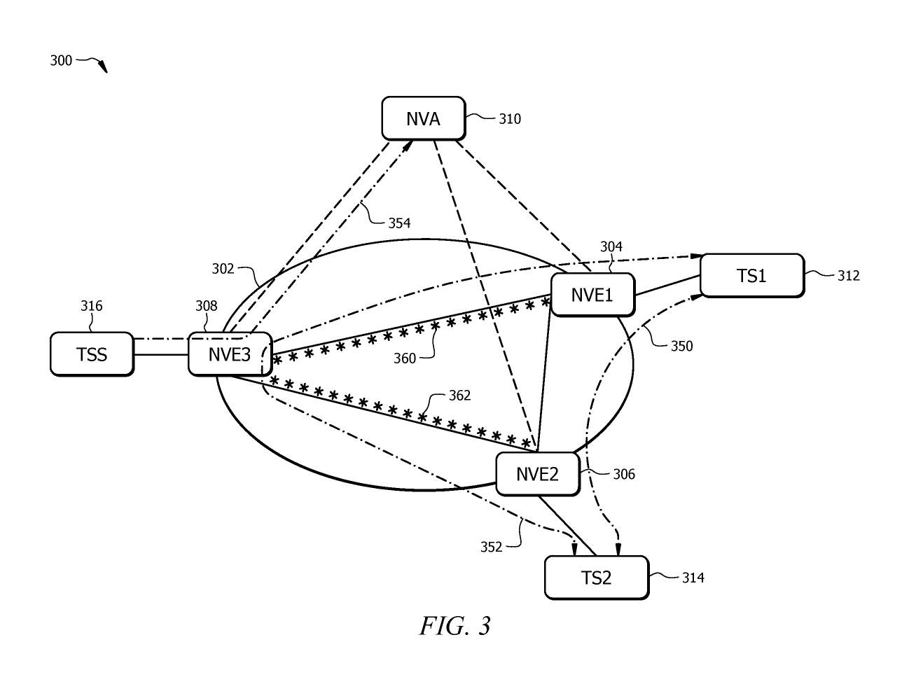

FIG. 3 is a schematic diagram of an embodiment of tenant traffic offloading in a tenant network 300. Tenant network 300 may be implemented by DC NVO 100 described in FIG. 1. As such, DC architecture 302, NVEs 304-308, NVA 310, tenant systems 312 and 314, and tenant service system 316 may be configured similar to DC infrastructure 102, NVEs 104-108, NVA 110, tenant systems 112 and 114, and tenant service system 116 described in FIG. 1, respectively.

For illustrative purposes, tenant system 312 may be configured as a sender tenant system and tenant system 314 may be configured as a receiver tenant system. Prior to offloading tenant traffic, tenant traffic may be communicated from tenant system 312 to tenant service system 316 and then from tenant service system 316 to tenant system 314. Tenant service system 316 or an entity behind the tenant service system 316 (e.g., a tenant controller) may decide to offload tenant traffic between tenant system 312 and tenant system 314. A network operator may provide one or more conditions and/or rules for when to offload tenant traffic. For example, tenant traffic may be offloaded upon determining NVE 304 and 306 support tenant traffic offloading. Tenant service system 316 may be configured to send an offload traffic notification 354 to NVE 308 and/or to NVA 310. The offload traffic notification 354 may comprise a sender tenant system address (e.g., an IP address or a media access control (MAC) address), a receiver tenant system address (e.g., an IP address or a MAC address), an operation action (e.g., unidirectional flow or bidirectional flow), policy information (e.g., an offload policy), an offload duration, an offload end condition, and/or any other suitable information as would be appreciated by one of ordinary skill in the art upon viewing this disclosure. A unidirectional flow may indicate to offload tenant traffic in one direction, for example, from tenant system 312 to tenant system 314, or vice versa. A bidirectional flow may indicate to offload tenant traffic in both directions between tenant system 312 and tenant system 314. An offload policy may include, but is not limited to, no policy, one or more filtering rules, a TCP application, and a hypertext transfer protocol (HTTP) application.

When NVA 310 is configured to receive the offload traffic notification 354, the NVA 310 may be configured to determine or to resolve a network mapping and to generate a network mapping message that comprises the network mapping. The network mapping may comprise inner/outer mappings (e.g., edge mappings), for example, a mapping between a tenant system and an NVE associated (e.g., coupled) with the tenant system, tenant system address mappings, and/or NVE location address mappings. The NVA 310 may also resolve a sender tenant system address and/or a receiver tenant system address that is associated with one or more virtual networks (e.g., virtual networks 360 and 362). NVA 310 may be configured to send a network mapping message to install the network mapping (e.g., inner/outer mapping and/or the tenant system addressing) on NVE 304 when the operation action in the offload traffic notification 354 indicates a unidirectional flow. The network mapping may comprise a mapping between NVE 306 and tenant system 314. NVA 310 may also send a second network mapping message to install a second network mapping on NVE 306 when the operation action in the offload traffic notification 354 indicates a bidirectional flow. The second network mapping may comprise a mapping between NVE 304 and tenant system 312. NVA 310 may be configured to push (e.g., to send) policy information to the sender tenant system and/or the NVE associated with the sender tenant system which may be used to differentiate an offload tenant traffic route from other tenant traffic routes (e.g., existing tenant traffic routes). In an embodiment, the network mapping message may contain the policy information. The policy information may include, but is not limited to, an indication whether the offload tenant traffic route is unidirectional or bidirectional, a non-reordering request, a duration of time for offloading tenant traffic, and an end condition for offloading tenant traffic. For example, NVA 310 may be configured to send policy information to NVE 304. NVE 304 may be configured to use the policy information and/or the network mapping message to generate a policy based routing (PBR) entry to differentiate an offload tenant traffic route from other tenant traffic routes. A PBR entry may be configured to identify an offload tenant traffic route to forward offloaded tenant traffic and/or may associate the offload tenant traffic route to one or more conditions (e.g., policies) and/or actions that may be applied to the offloaded tenant traffic. When NVE 304 receives tenant traffic from tenant system 312 that is for tenant system 314, NVE 304 may be configured to apply the PBR entry policy to the tenant traffic and to send the tenant traffic, accordingly. For example, NVE 304 may apply one or more policies to the tenant traffic and may send the tenant traffic using offload tenant traffic route 350. In an embodiment, the one or more policies may not be applied to one or more other tenant traffic flows between a sender tenant system and a receiver tenant system. Offload tenant traffic route 350 may be configured as a path along tenant system 312, NVE 304, NVE 306, and tenant system 314. As, such offload tenant traffic route 350 may not pass through NVE 308 nor tenant service system 316.

NVA 310 may send forwarding instructions to NVE 308 when NVA 310 is configured to reroute tenant traffic through NVE 308, but not through tenant service system 316. For example, the forwarding instructions may comprise instructions to forward tenant traffic received from NVE 304 to NVE 306 without forwarding the tenant traffic to the tenant service system 316 using offload tenant traffic route 352. Offload tenant traffic route 352 may be configured as a path along tenant system 312, NVE 304, NVE 308, NVE 306, and tenant system 314. As, such offload tenant traffic route 350 may not pass through tenant service system 316. Alternatively, when NVE 308 is configured to receive the offload traffic notification 354, tenant traffic may be offloaded similar to as previously described with respect to NVA 310. In another embodiment, tenant system 314 may be configured to request non-reordering of offloaded tenant traffic. NVE 304 may be configured to cache and/or to temporarily insert a sequence number on the overlay header of the tenant traffic. NVE 306 may be configured to reorder the received tenant traffic prior to forwarding the tenant traffic to tenant system 314.

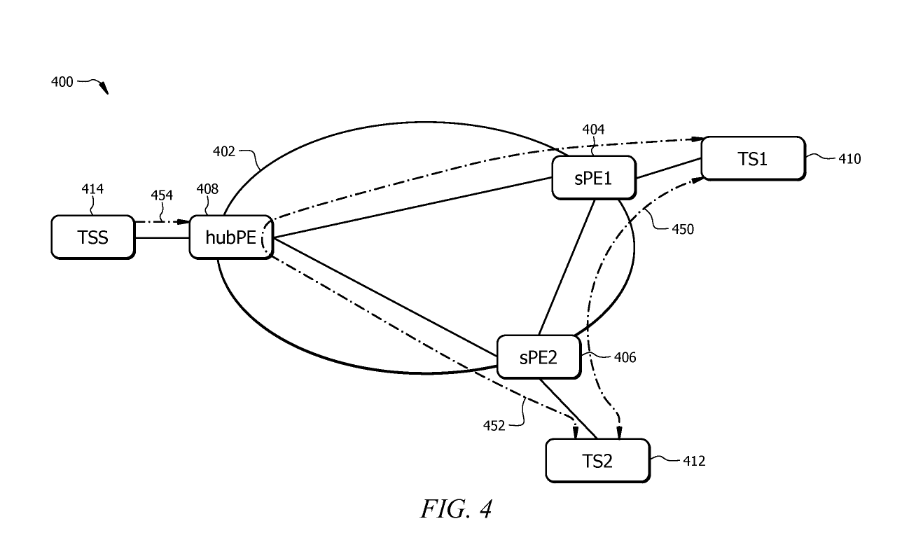

FIG. 4 is a schematic diagram of another embodiment of tenant traffic offloading in a tenant network 400. Tenant network 400 may be configured as a VPN (e.g., an L3 VPN or an L2 VPN). Tenant network 400 may be configured to implement tenant traffic offloading using a border gateway protocol (BGP). For example, a VPN using BGP may be implemented as described in IETF request for comments (RFC) 4364 titled, “BGP/MPLS IP Virtual Private Networks (VPNs),” by Rosen, et al., which is hereby incorporated by reference as if reproduced in its entirety. Tenant network 400 may comprise a multiprotocol label switching (MPLS) wide area network (WAN) network 402 that comprises a plurality of provider edges (PEs) 404-408, a hub site 414, and spoke sites 410 and 412. PE 408 may be referred to as a hub PE (hubPE) and may be coupled to hub site 414. PE 404 may be coupled to spoke site 410 and PE 406 may be coupled to spoke site 412 and each may be referred to as a spoke PE (sPE). Hub site 414 may be configured to provide one or more tenant service functions. For example, hub site 414 may comprise a tenant service system. Hub site 414 may be configured to trigger tenant traffic offloading (e.g., send an offload traffic notification) and to apply and/or to enforce tenant service functions, policies, and/or applications onto tenant traffic or tenant traffic flows that pass through the hub site 414. Hub site 414 may be configured to trigger tenant traffic offloading using an automated policy and/or may be initiated by a user command or trigger. Spoke sites 410 and 412 may each be configured as clients and may comprise a tenant system.

For illustrative purposes, spoke site 410 may be configured as a sender tenant system, spoke site 412 may be configured as a receiver tenant system, and hub site 414 may be configured as a tenant service system. Prior to offloading tenant traffic, tenant traffic may be communicated from spoke site 410 to hub site 414 and then from hub site 414 to spoke site 412. Hub site 414 (e.g., the tenant service system) may decide to offload tenant traffic between spoke site 410 and spoke site 412. Hub site 414 may be configured to send an offload traffic notification 454 to PE 408. The offload traffic notification 454 may be similar to offload traffic notification 354 described in FIG. 3. PE 408 may be configured to determine or to resolve a network mapping and to generate a network mapping message that comprises the network mapping. The network mapping may comprise inner/outer mappings (e.g., edge mappings), for example, a mapping between a spoke site and a PE associated (e.g., coupled) to the spoke site, spoke site address mappings, tenant system address mappings, and/or PE location address mappings. PE 408 may also resolve a sender spoke site address and a receiver spoke site address. PE 408 may be configured to send a network mapping message that comprises the network mapping (e.g., the inner/outer mappings, the spoke site addressing, and/or the tenant system addressing) to one or more PEs. For example, PE 408 may be configured to send the network mapping message that comprises a network mapping to PE 404 when the operation action in the offload traffic notification 454 indicates a unidirectional flow. The network mapping may comprise a mapping between PE 406 and spoke site 412. PE 408 may also be configured to send a second network mapping message that comprises a second network mapping to PE 406 when the operation action in the offload traffic notification 454 indicates a bidirectional flow. The second network mapping may comprise a mapping between PE 404 and spoke site 410. PE 408 may be configured to send policy information to the spoke sites and/or to the PEs associated with the spoke sites which may be used to differentiate an offload tenant traffic route from other tenant traffic routes (e.g., existing tenant traffic routes). For instance, PE 408 may be configured to send policy information to PE 404 and/or spoke site 410. PE 404 may be configured to use the policy information, the offload traffic notification, and/or the network mapping to generate a prefix (e.g., a BGP prefix) to differentiate an offload tenant traffic route from other tenant traffic routes. When PE 404 receives tenant traffic from spoke site 410 that is for spoke site 412, PE 404 may be configured to apply the prefix to the tenant traffic and may send the tenant traffic, accordingly. For example, PE 404 may apply one or more policies to the tenant traffic and may send the tenant traffic using offload tenant traffic route 450. In an embodiment, the one or more policies may not be applied to one or more other tenant traffic flows between a sender tenant system and a receiver tenant system. Offload tenant traffic route 450 may be configured as a path along spoke site 410, PE 404, PE 406, and spoke site 412. As, such offload tenant traffic route 450 may not pass through PE 408 nor hub site 414.

Hub site 414 may be configured to send forwarding instructions to PE 408 when PE 408 is configured to reroute tenant traffic through PE 408, but not through hub site 414. The forwarding instructions may comprise instructions to forward the tenant traffic received from PE 404 to PE 406 without forwarding the tenant traffic to the hub site 414 using offload tenant traffic route 452. Offload traffic route 422 may be configured as a path along spoke site 410, PE 404, PE 408, PE 406, and spoke site 412. As, such offload traffic route 452 may not pass through hub site 414.

In an embodiment, a spoke site may be configured to request non-reordering of offloaded tenant traffic. For example, PE 404 may be configured to cache and/or to temporarily insert a sequence number on the header of tenant traffic. PE 406 may be configured to reorder the received tenant traffic prior to forwarding the tenant traffic to spoke site 412.

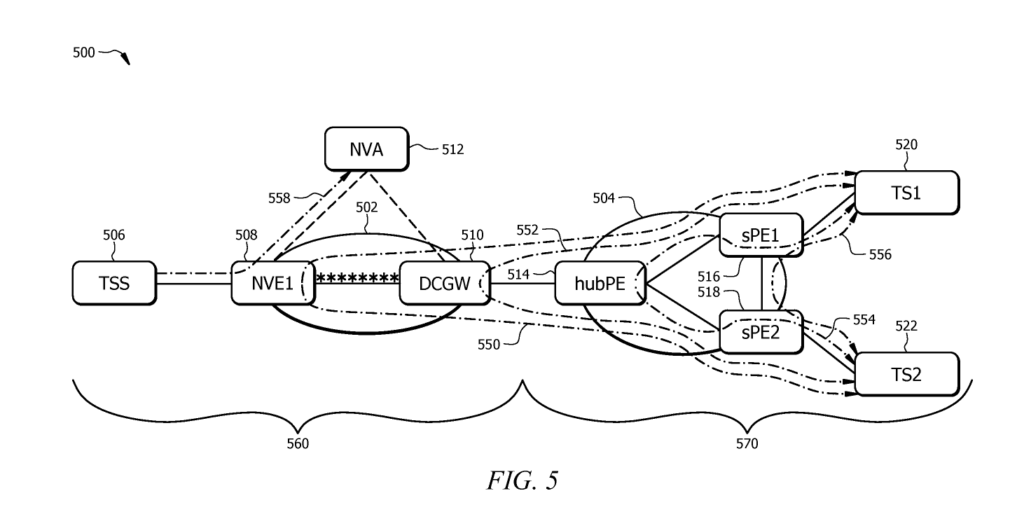

FIG. 5 is a schematic diagram of another embodiment of tenant traffic offloading in a tenant network 500. Tenant network 500 may comprise a DC network portion 560 coupled to a VPN network portion 570. DC network portion 560 may be configured similar to tenant network 300 described in FIG. 3 and VPN network portion 570 may be configured similar to tenant network 400 described in FIG. 4. DC network portion 560 may comprise a tenant service system 506 coupled to a DC architecture 502 that comprises NVE 508, NVE 510, and NVA 512. NVE 508 may be coupled with tenant service system 506 and NVE 510. NVE 510 may be configured as a DC gateway (DCGW). NVA 512 may be in data communication with tenant service system 506, NVE 508, and/or NVE 510. VPN network portion 570 may comprise an L3 VPN network (e.g., an MPLS WAN network) 504, a plurality of PEs 514-518, and spoke sites 520 and 522. PE 514 may be configured as a hub PE and may be coupled to NVE 510. PE 514 may also be coupled to PE 516 and 518. PE 516 may be configured as a spoke PE and may be coupled to spoke site 520. PE 518 may be configured as a spoke PE and may be couple to spoke site 522. Spoke site 520 and 522 may comprise a tenant system and/or may be configured as a tenant system.

For illustrative purposes, spoke site 520 may be configured a sender tenant system and spoke site 522 may be configured as a receiver tenant system. Prior to offloading tenant traffic, tenant traffic may be communicated from spoke site 520 to the tenant service system 506 and from the tenant service system 506 to the spoke site 522. Tenant service system 506 or an entity behind the tenant service system 506 (e.g., a tenant controller) may decide to offload tenant traffic between spoke site 520 and spoke site 522. Tenant service system 506 may be configured to send an offload traffic notification 558 to NVE 508 and/or to NVA 512. The offload traffic notification 558 may be similar to offload traffic notification 354 described in FIG. 3.

When NVA 512 is configured to reroute tenant traffic, the NVA 512 may be configured to resolve a network mapping, for example, an inner/outer mapping (e.g., edge mapping) between spoke sites 520 and 522 and the PEs 516 and 518 that are associated with spoke sites 520 and 522 and to generate a network mapping message that comprises the network mapping. NVA 512 may also resolve a sender tenant system address and a receiver tenant system address that is associated with one or more virtual networks. NVA 512 may be configured to send the network mapping message to install the inner/outer mapping and the tenant system addressing on one or more NVEs (e.g., NVE 508 and/or NVE 510) and to push (e.g., send) policy information as described in FIG. 3. NVE 510 may be configured to generate a PBR entry using the policy information and/or the network mapping message to differentiate an offload tenant traffic route from other tenant traffic routes. As such, NVE 510 may be configured to apply the PBR entry policy to the tenant traffic to apply one or more policies to the tenant traffic and may send tenant traffic using offload tenant traffic route 552. Offload tenant traffic route 552 may be configured as a path along spoke site 520, PE 516, PE 514, NVE 510, PE 518, and spoke site 522. As, such offload tenant traffic route 552 may not pass through NVE 508 nor tenant service system 506.

When NVA 512 is configured to reroute tenant traffic through NVE 508, but not through tenant service system 506, NVA 512 may send forwarding instructions to NVE 508 in response to receiving the offload traffic notification 558. The forwarding instructions may comprise instructions to forward tenant traffic without forwarding the tenant traffic to the tenant service system 506 using offload tenant traffic route 550. Offload tenant traffic route 550 may be configured as a path along spoke site 520, PE 516, PE 514, NVE 510, NVE 508, PE 518, and spoke site 522. As, such offload tenant traffic route 550 may not pass through tenant service system 506.

In an embodiment, tenant traffic may be offloaded from the DC network portion 560 of the tenant network 500. PE 514 may be configured to receive an offload traffic notification from tenant service system 506. When PE 514 is configured to reroute tenant traffic, PE 514 may be configured to determine or to resolve inner/outer mappings (e.g., edge mappings) between spoke sites 520 and 522 and the PEs 516 and 518 that are associated with spoke sites 520 and 522 and to generate a network mapping message that comprises the network mapping. PE 514 may also resolve a sender spoke site address and a receiver spoke site address. PE 514 may be configured to send the network mapping message that comprises the inner/outer mappings, the spoke site addressing, and/or the tenant system addressing to one or more PEs as described in FIG. 4. PE 514 may be configured to send policy information to the spoke sites and/or to the PEs associated with the spoke sites which may be used to differentiate an offload tenant traffic route from other tenant traffic routes (e.g., existing tenant traffic routes). For instance, PE 514 may be configured to send policy information to PE 516 and/or spoke site 520. PE 516 may be configured to use the policy information and/or the network mapping message to generate a prefix to differentiate an offload tenant traffic route from other tenant traffic routes. When PE 516 receives tenant traffic from spoke site 520 that is for spoke site 522, PE 516 may be configured to apply the prefix to the tenant traffic, to apply one or more policies to the tenant traffic, and to send the tenant traffic using offload tenant traffic route 556. Offload tenant traffic route 556 may be configured as a path along spoke site 520, PE 516, PE 518, and spoke site 522. As, such offload tenant traffic route 554 may not pass through PE 514, tenant service system 506, nor the DC network portion 560.

When PE 514 is configured to reroute tenant traffic through PE 514, but neither through tenant service system 506 nor the DC network portion 560, tenant service system 506 may be configured to send forwarding instructions to PE 514 in response to receiving the offload traffic notification 558. The forwarding instructions may comprise instructions to forward the tenant traffic from PE 516 to PE 518 without forwarding the tenant traffic to the tenant service system 506 and/or to the DC network portion 560 using offload tenant traffic route 554. Offload tenant traffic route 554 may be configured as a path along spoke site 520, PE 516, PE 514, PE 518, and spoke site 522. As, such offload tenant traffic route 554 may not pass through tenant service system 506 nor the DC network portion 560. Additionally, a spoke site may be configured to request non-reordering of offloaded tenant traffic which may be implemented as described in FIGS. 3 and 4.

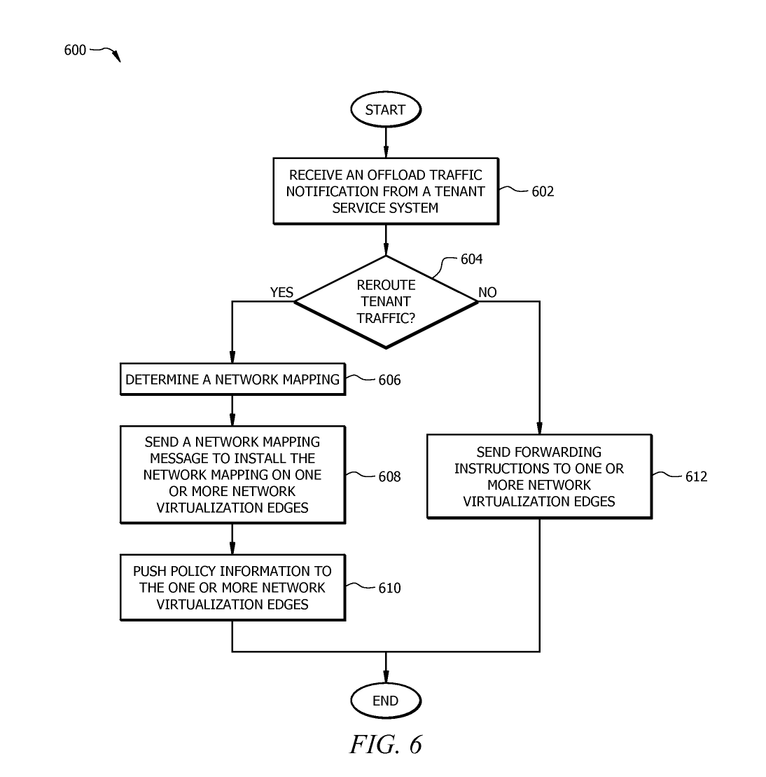

FIG. 6 is a flowchart of an embodiment of an offloading tenant traffic method 600 for a network node and may be similar to tenant traffic offload module 260 described in FIG. 2. In an embodiment, a network node (e.g., NVA 310 or NVEs 304-308 described in FIG. 3) may be configured to receive an offload traffic notification, to determine whether to reroute tenant traffic within a tenant network, to determine a network mapping, and to send a network mapping message that comprises the network mapping to install the network mapping onto one or more other network nodes (e.g., NVEs 304-308 described in FIG. 3) in the tenant network. A tenant service system or a tenant controller may decide to offload the traffic between a first tenant system and a second tenant system (e.g., tenant systems 312 and 314) and may send an offload traffic notification to the network node. At step 602, the network node may receive the offload traffic notification from the tenant service system. The offload traffic notification may comprise a sender tenant system address (e.g., an IP address or a MAC address), a receiver tenant system address (e.g., an IP address or a MAC address), an operation action (e.g., unidirectional flow or bidirectional flow), an offload policy, an offload duration, an offload end condition, and/or any other suitable information as would be appreciated by one of ordinary skill in the art upon viewing this disclosure. A unidirectional flow may indicate to offload tenant traffic in one direction, for example, from the first tenant system to the second tenant system, or vice versa. A bidirectional flow may indicate to offload tenant traffic in both directions between the first tenant system and the second tenant system. An offload policy may include, but is not limited to, no policy, one or more filtering rules, a TCP application, and an HTTP application. At step 604, the network node may determine whether to reroute tenant traffic to bypass an NVE associated with the tenant service system. For example, the network node may determine whether to reroute tenant traffic to bypass an NVE associated with tenant service system based on a policy provided by a network operator. When the network node is configured to and/or determines to reroute tenant traffic to bypass an NVE associated with the tenant service system, the network node may proceed to step 606; otherwise, the network node may proceed to step 612. At step 606, the network node may determine a network mapping. The network node may resolve inner/outer mapping (e.g., edge mapping) between a tenant system and an NVE that is associated with the tenant system, tenant system address mappings, and/or NVE location address mappings. The network node may also resolve a sender tenant system address and a receiver tenant system address that is associated with one or more virtual networks. The network mapping may further comprise one or more virtual identifiers (IDs) that identify the virtual networks associated with the sender tenant system and/or the receiver tenant system. At step 608, the network node may send a network mapping message that comprises the network mapping to install the network mapping onto one or more other network nodes in the tenant network. For example, the network node may send the network mapping message to install the network mapping to an NVE attached to a sender tenant system or a receiver tenant system when the operation action in the offload traffic notification indicates unidirectional flow. The network node may send the network mapping message to a first NVE associated with a sender tenant system and to a second NVE associated with a receiver tenant system when the operation action in the offload traffic notification indicates a bidirectional flow. At step 610, the network node may push policy information to one or more NVEs to distinguish an offload tenant traffic route from existing tenant traffic routes. For instance, PBR may be implemented to distinguish an offload tenant traffic route that bypasses a tenant service system from another tenant traffic route that passes through the tenant service system. In an embodiment, the network mapping message may comprise the policy information.

Returning to step 604, when the network node is not configured to reroute tenant traffic to bypass the NVE associated with the tenant service system, the network node may proceed to step 612. At step 612, the network node may send forwarding instructions to one or more other network nodes. For example, the network node may send forwarding instructions to an NVE associated with the tenant service system. The forwarding instructions may comprise instructions to forward tenant traffic from an NVE associated with a sender tenant system to an NVE associated with a receiver tenant system without forwarding the tenant traffic to the tenant service system.

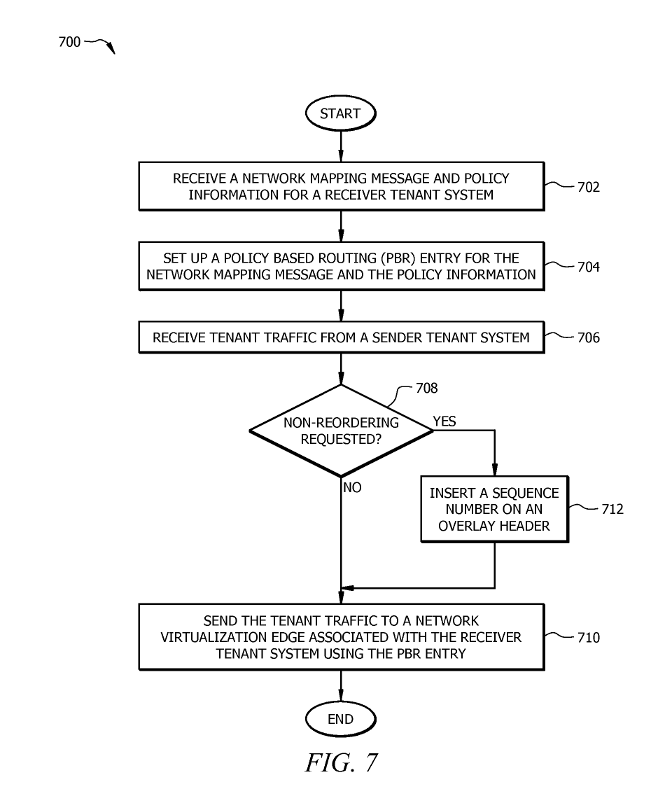

FIG. 7 is a flowchart of another embodiment of an offloading tenant traffic method 700 for a network node and may be similar to tenant traffic offload module 260 described in FIG. 2. In an embodiment, a network node (e.g., NVE 308 described in FIG. 3) may be configured to receive a network mapping message and policy information for a receiver tenant system, to set up a PBR entry to offload tenant traffic, and to send tenant traffic using the PBR entry. At step 702, an NVE may receive a network mapping message and policy information from an NVA (e.g., NVA 310 described in FIG. 3). The network mapping message may comprising information for routing or rerouting tenant traffic and may be as described in step 606 in FIG. 6. At step 704, the NVE may set up a PBR entry for the network mapping message and the policy information for the receiver tenant system. The NVE may receive policy information for distinguishing one or more rerouted tenant traffic routes from existing tenant traffic routes and may set up a PBR entry using the received policy information and/or the network mapping message. At step 706, the NVE may receive tenant traffic from a tenant system associated with the NVE. At step 708, the NVE may determine if non-reordering has been requested by the tenant system associated with the NVE. For example, the NVE may determine whether non-reordering has been requested using the policy information in the offload traffic notification. When non-reordering has been requested, the NVE may proceed to step 712; otherwise, the NVE may proceed to step 710. At step 710, the NVE may send the tenant traffic to an NVE associated with a receiver tenant system using the PBR entry. Sending the tenant traffic using the PBR entry may comprise applying one or more policies to one or more tenant traffic flows and sending the one or more tenant traffic flows to the NVE associated with the receiver tenant system. When offloading tenant traffic, the NVE may encapsulate data packets with a virtual network ID and an address for the NVE associated with the receiver tenant system as an outer address and may send the encapsulated tenant traffic. When not offloading tenant traffic, the NVE may encapsulate data packets with a virtual network ID and an address for the NVE associated with the tenant service system as an outer address and may send the encapsulated tenant traffic.

Returning to step 708, when non-reordering has been requested, the NVE may proceed to step 712. At step 712, the NVE may insert a sequence number on an overlay header of the data packets for the tenant traffic and may proceed to step 710. The NVE may cache and/or temporarily insert a sequence number on the header (e.g., an overlay header) of the data packets for the tenant traffic, such as, virtual extensible local area networks (VXLAN) or network virtualization using generic routing encapsulation (NVGRE). Inserting a sequence number may allow an NVE associated with the receiver tenant system to reorder packets prior to sending them to the receiver tenant system.

At least one embodiment is disclosed and variations, combinations, and/or modifications of the embodiments and/or features of the embodiments made by a person having ordinary skill in the art are within the scope of the disclosure. Alternative embodiments that result from combining, integrating, and/or omitting features of the embodiments are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*−R₁), wherein k is a variable ranging from 1 percent to 100 percent with a 1 percent increment, e.g., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. An apparatus comprising:
a receiver configured to receive an offload traffic notification from tenant service system; and
a processor coupled to a memory and the receiver, where the memory comprises computer executable instructions stored in a non-transitory computer readable medium, that when executed by the processor, cause the processor to:
receive the offload traffic notification, wherein the offload traffic notification identifies a sender tenant system and a receiver tenant system and comprises policy information;
determine a network mapping between a network virtualization edge (NVE) that is associated with the receiver tenant system and the receiver tenant system;
generate a network mapping message that comprises the network mapping; and
send the network mapping message and policy information within a network to an NVE that is associated with a sender tenant system.

2. The apparatus of claim 1, wherein determining the network mapping comprises:
send a network mapping request; and
receive the network mapping in response to the network mapping request.

3. The apparatus of claim 1, wherein the policy information comprises one or more policies to apply to one or more tenant traffic flows between the sender tenant system and the receiver tenant system.

4. The apparatus of claim 3, wherein the policy information does not apply the one or more policies to at least one tenant traffic flow between the sender tenant system and the receiver tenant system.

5. The apparatus of claim 3, wherein the one or more policies maintain packet ordering for the one or more tenant traffic flows between the sender tenant system and the receiver tenant system.

6. The apparatus of claim 1, wherein determining the network mapping comprises determining a virtual network associated with a receiver tenant system.

7. The apparatus of claim 1, wherein the offload traffic notification indicates whether a traffic flow is unidirectional or bidirectional.

8. The apparatus of claim 7, wherein the computer executable instructions further cause the processor to send a second network mapping message to an NVE associated with a receiver tenant system when the offload traffic notification indicates the traffic flow is bidirectional.

9. The apparatus of claim 1, wherein the network is one of a network virtualization overlay (NVO) or a virtual private network (VPN).

10. A traffic offloading method comprising:
receiving a policy information that comprises one or more policies and a network mapping message that comprises a network mapping between a receiver tenant system and a network virtualization edge (NVE) associated with the receiver tenant system;
generating a policy based routing entry in accordance with the policy information and the network mapping information;
receiving tenant traffic intended for the receiver tenant system from a sender tenant system; and
sending the tenant traffic within a network to an NVE associated with the receiver tenant system using the policy based routing entry, wherein sending the tenant traffic using the policy based routing applies the policy information to the tenant traffic, and wherein sending the tenant traffic using the policy base routing entry bypasses a tenant service system.

11. The method of claim 10, wherein generating the policy based routing entry comprises generating a border gateway protocol (BGP) prefix, and wherein sending the tenant traffic comprises using the BGP prefix.

12. The method of claim 10, further comprising determining a virtual network identifier (ID) for the receiver tenant system, and wherein sending the tenant traffic comprises encapsulating the virtual network ID and an address of the NVE associated with the receiver tenant system.

13. The method of claim 10, further comprising:
determining that non-reordering is requested by the receiver tenant system; and
inserting a sequence number in an overlay header of the tenant traffic for the receiver tenant system.

14. The method of claim 10, wherein the network is one of a virtual private network (VPN) or a network virtualization overlay (NVO) network.

15. The method of claim 10, wherein the network mapping comprises an address for a receiver tenant system and an address for the NVE associated with the receiver tenant system

16. In a network, a traffic offloading method comprising:
receiving an offload traffic notification, wherein the offload traffic notification identifies a sender tenant system and a receiver tenant system and comprises policy information, and wherein the offload traffic notification indicates a bidirectional traffic flow between the sender tenant system and the receiver tenant system;
determining a first network mapping between the sender tenant system and a network virtualization edge (NVE) associated with the sender tenant system and a second network mapping between the receiver tenant system and an NVE associated with the receiver tenant system;
generating a first network mapping message that comprises the first network mapping and a second network mapping message that comprises the second network mapping in response to receiving the offload traffic notification; and
sending the first network mapping message and the policy information to the NVE associated with the receiver tenant system and the second network mapping message and the policy information to the NVE associated with the sender tenant system within a network.

17. The method of claim 16, wherein the policy information comprises one or more policies to apply to one or more tenant traffic flows between the sender tenant system and the receiver tenant system.

18. The method of claim 16, wherein determining the first network mapping and the second network mapping comprises:
sending a network mapping request; and
receiving the network mapping in response to the network mapping request.

19. The method of claim 16, wherein determining the first network mapping and the second mapping comprises determining a virtual network associated with the sender tenant system, the receiver tenant system, or both.

20. The method of claim 16, wherein the network is one of a network virtualization overlay (NVO) or a virtual private network (VPN).
